(19) United States
(12) Patent Application Publication
(10) Pub. No.: US 2002/0073775 A1
(43) Pub. Date: Jun. 20, 2002

(54) Graduated fluid measuring device

(76) Inventors: Michael J. Allein, Amherst, NY (US); Dwight E. Witherow, Tonawanda, NY (US)

Correspondence Address: Law Offices of John D. Gugliotta, P.E., Esq., 202 Delaware Building, 137 South Main Street, Akron, OH, 44308, US

(21) Appl. No.: 09/740,303

(22) Filed: Dec. 18, 2000

(51) Int. Cl. G01F 23/02

(52) U.S. Cl. 73/325

(57) ABSTRACT

A graduated fluid measuring device is provided which aids in measuring the amount of liquid remaining in a large tank. A long, clear, rigid plastic tube is provided that is approximately 16 feet in total length. At least 14 feet of the tube would be marked in ⅛ inch increments. At the opposite end of the tube is a pivoting valve. The invention replaces and improves on the conventional method of “sticking” a tank that uses a wooden stick by operating on the principle of vacuum similar in nature to what occurs when a finger is placed over the opening of a straw and then removing the straw from the glass of liquid.

### RELATED APPLICATIONS

The present invention was first described in Disclosure Document No. 470,183 filed on Mar. 14, 2000. There are no previously filed, nor currently any co-pending applications, anywhere in the world.

### BACKGROUND OF THE INVENTION

1. Field of the Invention

The present invention relates generally to liquid volume measuring devices and, more particularly, to a graduated fluid measuring device.

2. Description of the Related Art

The traditional method of determining the level of liquid in a tank in an industrial setting has conventionally been to “stick” the tank. This entails taking a long wooden stick and inserting it in a port on the top of the tank until it hits the bottom. The stick is then removed and the border between the wet and the dry area is determined. A simple math calculation then determines the quantity of liquid inside. However, this method has a serious drawback. It is often difficult to determine the wet/dry border especially if outside in wet or windy conditions. Ambient light levels, which may not be adequate, play a significant factor as well. A miscalculation of tank level could have disastrous consequences should the tank run dry or possibly be overfilled.

Accordingly, there is a need for a means by which the level of the liquid in a tank or vessel can be accurately determined. The development of the graduated fluid measuring device fulfills this need.

A search of the prior art did not disclose any patents that read directly on the claims of the instant invention; however, the following references were considered related. The following patents disclose a dual tube acoustic level gage for measuring gasoline and water in a tank: U.S. Pat. No. 5,939,634 issued in the name of Johnson; U.S. Pat. No. 5,765,433 issued in the name of Johnson; U.S. Pat. No. 5,062,295 issued in the name of Shakkottai et al; and U.S. Pat. No. 4,748,846 issued in the name of Haynes.

The following patents describe a method of detecting leaks in an above ground petroleum storage tank: U.S. Pat. No. 5,347,849 issued in the name of Reeme et al.; U.S. Pat. No. 5,131,264 issued in the name of Jensen; and U.S. Pat. No. 4,736,622 issued in the name of Miller et al.

The following patents disclose a water sensor that detects leaks in a tank or vessel: U.S. Pat. No. 5,156,047 issued in the name of Tuma et al.; and U.S. Pat. No. 4,186,591 issued in the name of Mooney.

Consequently, a need has been felt for providing a device which allows for the determination of liquid level in tanks and vessels in a quick, easy, and accurate manner without the inherent disadvantages of conventional methods.

### SUMMARY OF THE INVENTION

Therefore, it is an object of the present invention to provide a graduated fluid measuring device which allows the determination of liquid level in tanks and vessels.

It is another object of the present invention to provide a device which functions better than a conventional wooden stick and can be used in rainy, and windy conditions.

It is still another object of the present invention to provide a device which operates similar to a sight glass.

It is still another object of the present invention to provide a device which saves time and money.

It is another object of the present invention to provide a graduated fluid measuring device with a plastic tube which is clear and rigid.

It is another object of the present invention to provide a graduated fluid measuring device with a plastic tube which is marked in ⅛ inch increments thereby providing extremely accurate readings and being more visible under low light conditions.

It is another object of the present invention to provide a graduated fluid measuring device with a pivoting valve located at an upper end of the plastic tube which allows for the forming and releasing of a vacuum.

Briefly described according to one embodiment of the present invention, a graduated fluid measuring device is provided which aids in measuring the amount of liquid remaining in a large tank. The invention is a long, clear, rigid plastic tube that is approximately 16 feet in total length. At least 14 feet of the tube would be marked in ⅛ inch increments. At the opposite end of the tube is a pivoting valve. The invention is used by opening the pivoting valve and inserting it into a tank or vessel through an open port until it rests on the bottom of the tank or vessel. The pivoting valve is then closed and the tube is withdrawn until the trapped liquid is visible in the tube. The level is read against the markings in the same manner similar to that of a sight glass. The pivoting valve is then opened, and the liquid is allowed to flow back into the tank. The invention replaces and improves on the conventional method of “sticking” a tank that uses a wooden stick by operating on the principle of vacuum similar in nature to what occurs when a finger is placed over the opening of a straw and then removing the straw from the glass of liquid.

The use of the present invention allows for the determination of liquid level in tanks and vessels in a quick, easy, and accurate manner without the inherent disadvantages of conventional methods.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of a graduated fluid measuring device according to the preferred embodiment of the present invention;

FIG. 2 is a bottom plan view of the pivoting valve according to the preferred embodiment of the present invention;

FIG. 3 is a top plan view of the collar according to the preferred embodiment of the present invention;

FIG. 4 is a partial side elevational view of the present invention according to the preferred embodiment shown with the pivoting valve in a closed position;

FIG. 5 is a side elevational thereof shown with the pivoting valve in an open position; and

FIG. 6 is a perspective view of the graduated fluid measuring device according to the preferred embodiment shown in-use.

### DESCRIPTION OF THE PREFERRED EMBODIMENT

1. Detailed Description of the Figures

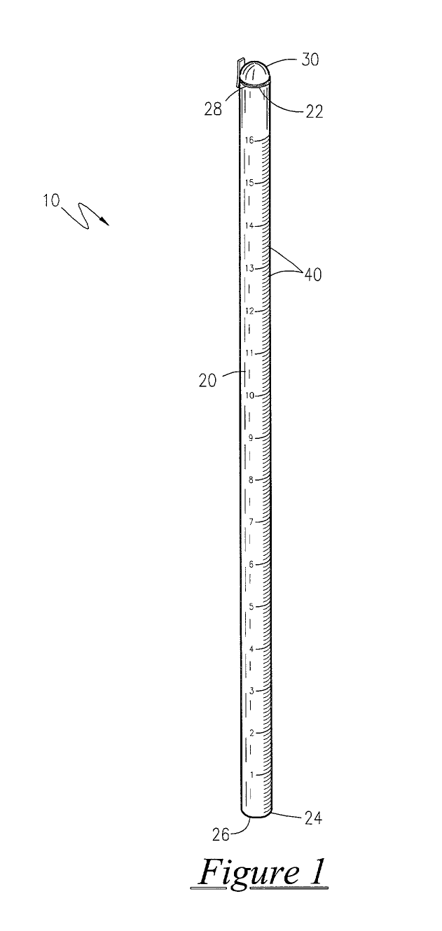

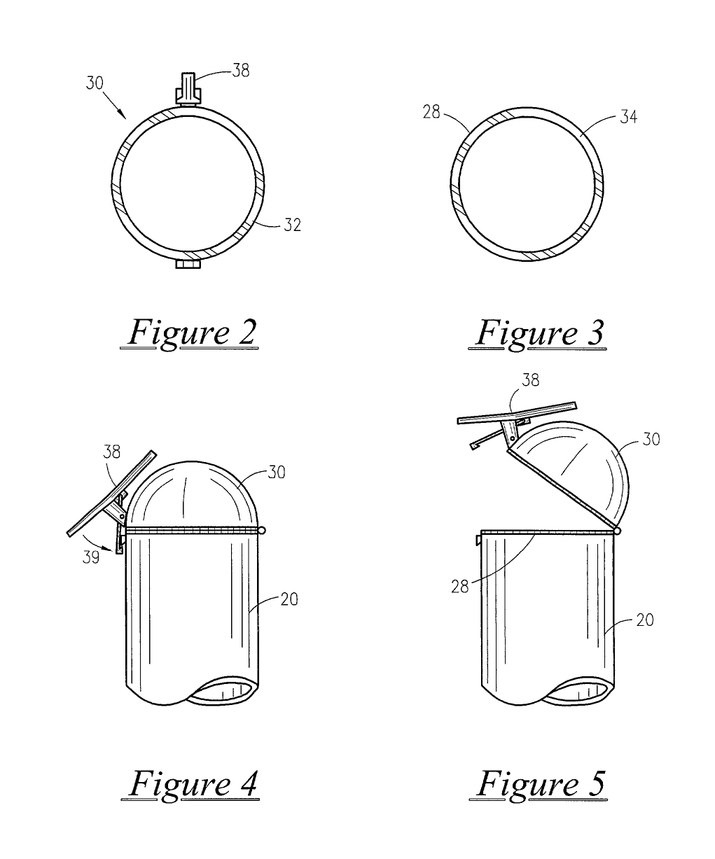

Referring now to FIGS. 1-5, a graduated fluid measuring device 10 is shown, according to the present invention, comprised of a linearly elongated cylindrical measuring tube 20 having an anterior end 22 opposite a posterior end 24 which aids in measuring an amount of fluid remaining in a large tank or fluid storage container such as an underground fuel storage tank.

The graduated fluid measuring device 10 (hereinafter referred to as measuring device 10) is constructed of a lightweight, rigid, transparent plastic material capable of injection molding, and therefore can be formed easily of recycled material. The plastic material utilized in constructing the measuring device 10 is chemical resistant and suitable with various fluids including but not limited to gasoline fuel, diesel fuel, and water.

The posterior end 24 of the measuring tube 20 is defined as a circular opening 26. The anterior end 22 of the measuring tube 20 comprises a circular opening forming a collar 28. The anterior end 22 is further comprised of a concave-shaped valve 30 pivotally attached to an external circumferential surface at the anterior end 22 of the measuring tube 20. The valve 30 has a thin, soft rubber membrane 32 circumferentially joined to an inner side thereof. The collar 28 also has a thin, soft rubber membrane 34 circumferentially joined to an upper surface thereof. Closing the valve 30 flat against the collar 28 forms an air-tight, fluid-impermeable seal. The thin, soft rubber membranes 32, 34 joined to the valve 30 and the collar 28 respectively, are constructed of chemical resistant rubber material.

For securely holding the valve 30 against the collar 28 in a closed position so as to form the air-tight, fluid-impermeable seal, a clamping bracket 38 is attached to the valve 30 at an end thereof opposite the valve's 30 pivotal attachment to the anterior end 22 of the measuring tube 20. Once the valve 30 is closed against the collar 28, the clamping bracket 38 is closed in an inward direction towards the external circumferential surface of the anterior end 22 of the measuring tube 20, depicted by direction arrow 39 shown in FIG. 4, thereby forming the air-tight, fluid-impermeable seal.

Referring now to FIG. 1, the measuring tube 20 extends to a length of approximately 16 feet. Measuring indicia 40 are provided along the external circumferential surface of the measuring tube 20 between the circular opening 26 of the posterior end 24 and a 16 foot measurement mark. The measuring tube 20 is further marked with measuring indicia 40 in ⅛ inch increments so as to provide precise measurements. It is envisioned that measuring tubes 20 of longer lengths may be required such as in cases where fluid storage containers have depths measuring greater than 16 feet, thus the length of the measuring tube 20 disclosed is only meant as a suggestion and is in no means limiting.

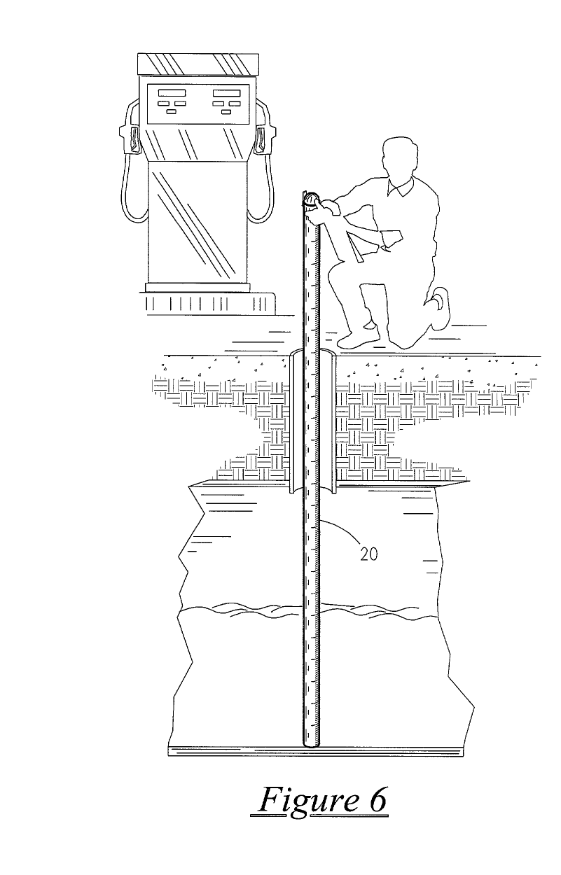

Referring now to FIGS. 1, 4, 5, and 6, in order to measure an amount of fluid in a large tank, the valve 30 is left in an open position (as shown in FIG. 5), and the measuring tube 20, posterior end 24 first, is inserted into the tank until the posterior end 24 meets the bottom thereof. Fluid enters the measuring tube 20 to a height equal to the depth of the fluid within the tank. The valve 30 is closed and secured to the collar 28 of the measuring tube 20 via the clamping bracket 38. The air-tight, fluid-impermeable seal formed by the closing of the valve 30 creates a vacuum within the measuring tube 20, thereby trapping and holding withdrawn fluid therein. The measuring tube 20 is removed from the tank to a point at which trapped fluid becomes visible and has a readable level. The readable level is measured against the measuring indicia 40 located along the external circumferential surface of the measuring tube 20 for determining the amount of fluid remaining in the tank, taking into consideration a particular volume of the tank utilized being dissimilar to volumes of other fluid storage containers.

Once a fluid measurement has been taken, the clamping bracket 38 is released and the valve 30 is opened, thereby removing the vacuum created within the measuring tube 20. The measuring tube 20 is subsequently removed from the tank and in doing so, the fluid within the measuring tube 20 flows back into the tank.

As an ancillary benefit of the present design, in the event an amount of fuel is to be measured within a gasoline fuel tank which also contains water, the design and configuration of the transparent measuring tube 20 of the present invention allows a user to quickly and easily discern the fuel from the water. Because water is a heavier liquid as compared to gasoline fuel, the water and the fuel will separate, wherein the fuel will rest above the water, as will be clearly visible through the transparent measuring tube 20.

2. Operation of the Preferred Embodiment

To use the present invention, the user leaves the valve 30 in an open position, and inserts the measuring tube 20, posterior end 24 first, into the fluid storage tank until the posterior end 24 meets the bottom thereof. Fluid enters the measuring tube 20 to a height equal to the depth of the fluid within the fluid storage tank. The user then closes the valve 30 and secures the valve 30 to the collar 28 of the measuring tube 20 via the clamping bracket 38 An air-tight, fluid-impermeable seal is formed by the closing of the valve 30 which creates a vacuum within the measuring tube 20, thereby trapping and holding withdrawn fluid therein. Next, the user removes the measuring tube 20 from the fluid storage tank to a point at which trapped fluid becomes visible and has a readable level. The user measures the readable level against the measuring indicia 40 located along the external circumferential surface of the measuring tube 20 for determining the amount of fluid remaining in the fluid storage tank. Once the user takes the fluid measurement, he releases the clamping bracket 38 which opens the valve 30, and in turn, removes the vacuum created within the measuring tube 20. The user subsequently removes the measuring tube 20 from the fluid storage tank and in doing so, the fluid within the measuring tube 20 flows back into the fluid storage tank.

The use of the present invention allows for the determination of liquid level in tanks and vessels in a quick, easy, and accurate manner without the inherent disadvantages of conventional methods.

Therefore, the foregoing description is included to illustrate the operation of the preferred embodiment and is not meant to limit the scope of the invention. As one can envision, an individual skilled in the relevant art, in conjunction with the present teachings, would be capable of incorporating many minor modifications that are anticipated within this disclosure. Therefore, the scope of the invention is to be broadly limited only by the following claims.

What is claimed is:

1. A graduated fluid measuring device comprising:
a linearly elongated cylindrical measuring tube having an anterior end opposite a posterior end, said posterior end of the measuring tube defined as a circular opening and said anterior end of the measuring tube comprises a circular opening forming a collar; and
a concave-shaped valve pivotally attached to an external circumferential surface at the anterior end of the measuring tube; wherein when said valve is securely held against said collar in a closed position an air-tight, fluid-impermeable seal is formed.

2. The graduated fluid measuring device of claim 1, wherein said valve further comprises a thin, soft rubber membrane circumferentially joined to an inner side thereof.

3. The graduated fluid measuring device of claim 2, wherein said collar also comprises a thin, soft rubber membrane circumferentially joined to an upper surface thereof; wherein closing said valve flat against said collar forms an air-tight, fluid-impermeable seal.

4. The graduated fluid measuring device of claim w, wherein said thin, soft rubber membranes joined to said valve and said collar respectively, are each constructed of chemical resistant rubber material.

5. The graduated fluid measuring device of claim 1, wherein said measuring tube is constructed of a lightweight, rigid, transparent plastic material capable of injection molding.

6. The graduated fluid measuring device of claim 1, further comprising a clamping bracket attached to said valve at an end thereof opposite the valve's pivotal attachment to said anterior end of the measuring tube such that when said valve is closed against said collar and said clamping bracket is closed in an inward direction towards the external circumferential surface of the anterior end of the measuring tube, an air-tight, fluid-impermeable seal is formed.

7. The graduated fluid measuring device of claim 1, wherein said measuring tube extends to a length of approximately 16 feet.

8. The graduated fluid measuring device of claim 7, further comprising measuring indicia along the external circumferential surface of the measuring tube between the circular opening of the posterior end and a 16 foot measurement mark.

9. The graduated fluid measuring device of claim 8, wherein said measuring indicia are in ⅛ inch increments.
